(19) United States
(12) Patent Application Publication
(10) Pub. No.: US 2019/0089500 A1
(43) Pub. Date: Mar. 21, 2019

(54) INTERFERENCE AND FADING MITIGATION IN OFDM SYSTEMS

(71) Applicant: ZTE España, S.L.U., Madrid (ES)

(72) Inventor: Miguel Arranz, Madrid (ES)

(21) Appl. No.: 15/711,728

(22) Filed: Sep. 21, 2017

(51) Int. Cl. H04L 5/00; H04L 5/14; H04W 72/12

(52) U.S. Cl. CPC H04L 5/0012; H04L 5/005; H04W 72/1273; H04W 72/1268; H04L 5/0073; H04L 5/14

(57) ABSTRACT

A technique for allocating transmission bandwidth in a wireless network includes logically organizing transmission resources along a two-dimensional grid of physical resource blocks (PRBs), where each PRB is made up of a first equal number of time slots along a time dimension and a second equal number of subcarriers along a frequency dimension; and allocating PRBs to data transmissions such that locations of PRBs are hopped for successive transmissions within the two-dimensional grid.

### TECHNICAL FIELD

This document relates to systems, devices and techniques for wireless communications.

### BACKGROUND

Efforts are currently underway to define next generation communication networks that provide greater deployment flexibility, support for a multitude of devices and services and different technologies for efficient bandwidth utilization.

### SUMMARY

This document describes technologies, among other things, for eliminating or minimizing interference in wireless systems that uses signals based on orthogonal frequency division multiplexing (OFDM).

In one example aspect, an example method implemented by a scheduler in a wireless network is disclosed. The method includes logically organizing transmission resources along a two-dimensional grid of physical resource blocks (PRBs), where each PRB is made up of a first equal number of time slots along a time dimension and a second equal number of subcarriers along a frequency dimension, and allocating PRBs to data transmissions such that locations of PRBs are hopped for successive transmissions within the two-dimensional grid.

In another example aspect, a wireless communication apparatus comprising a processor is disclosed. The processor is configured to implement the above-described method.

In yet another aspect, a computer program product comprising a computer-readable program medium is disclosed. The program medium has code stored thereon, the code, when executed, causes a processor to implement the above-described method.

The details of one or more implementations are set forth in the accompanying attachments, the drawings, and the description below. Other features will be apparent from the description and drawings, and from the claims.

### BRIEF DESCRIPTION OF THE DRAWINGS

FIG. 1 shows a graphical example of evolution of wireless systems.

FIG. 2 illustrates frequency hopping used in GSM systems.

FIG. 3 depicts examples of physical resource blocks (PRBs) eligible for hopping in a Subcarrier hopping scenario.

FIG. 4 depicts examples of PRB's eligible for hopping in Subframe hopping scenario.

FIG. 5 depicts examples of PRB's eligible for hopping in Frame Hopping.

FIG. 6 illustrates an example implementation of a Non-load sensitive algorithm.

FIG. 7 illustrates an example implementation of a Load sensitive algorithm.

FIG. 8 is a flowchart illustrating an example method of wireless communications.

FIG. 9 is a block diagram of an example of a wireless communication apparatus.

FIG. 10 is a block diagram of an example of a wireless network.

Like reference symbols in the various drawings indicate like elements.

### DETAILED DESCRIPTION

Currently the explosion of mobile data services is posing a large set of challenges to mobile operators, that are stressed also by the reduced margins obtained through their data offerings. In this context, the overall wireless industry is looking for technologies and solutions that (1) are technically feasible to cater the exponential data volume growth. For example, a 7-fold data growth has been recently forecasted by Cisco Inc. between 2016 and 2021; and (2) are able to reduce the cost per data unit as enabler for a healthier and workable mobile internet deployment. One of the issues nowadays is the decoupling of revenue of data traffic from its volume, what jeopardizes the future of the Networks development worldwide.

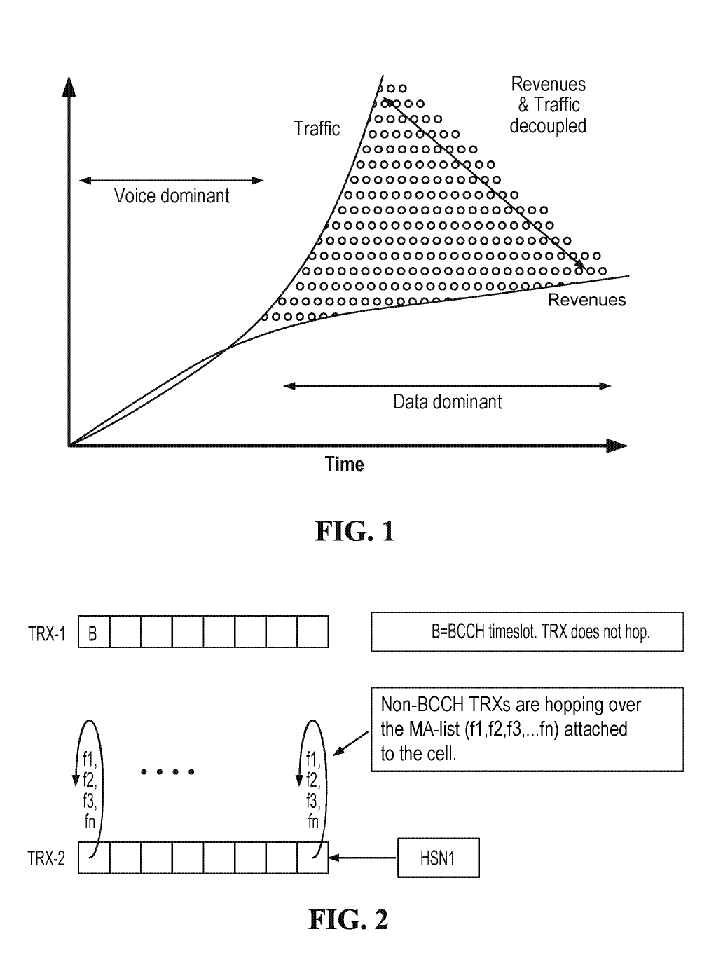

FIG. 1 gives a graphical view of the above-described challenges. The net traffic carried by wireless networks and the corresponding revenues are plotted as two curves along the vertical axis, with the horizontal axis representing time. The wireless networks, which once were voice dominant, and therefore displayed a hand-in-hand growth in bandwidth and network traffic, are becoming more and more data-centric. The explosive growth in data is due to various reasons such as growth in the number of multimedia user devices such as smartphones and tablets and services providers that provide content using internet based streaming. This explosive growth in data is, however, not translating into any significant growth in revenue (e.g., as was the case for voice-dominant networks). Therefore, network operators are looking for ways by which to reduce both capital expenses and operational expenses associated with accommodating the growth in wireless traffic.

The above-mentioned two factors result into a clear need to improve spectrum efficiency and overall performance of the existing and the future radio access networks (RAN). One of the techniques that has proved to be more efficient in OFDM systems is the Coordinated multipoint (CoMP) Scheduling across eNodeB's, as part of the CoMP set of functions standardized by the Third Generation Partnership Project (3GPP). This presents a benefit as PRB's (Physical Resource Blocks) are scheduled in a coordinated way across different eNode B's, preventing specially in the border region between cells interference caused by two (or more users) accessing the same PRB's of their respective cells. An ideal coordinated scheduling requires fiber to the enode Bs and strict synchronization, due to the double requirements in terms of latency and bandwidth. One of the key drivers for the Cloud Radio new architecture paradigm is precisely the benefit of an ideal coordination between eNode B's at Radio Physical Layer.

Unfortunately, Cloud Scheduling and CoMP have not succeeded in the market as initially envisaged, possibly due to the bandwidth, latency and synchronization prerequisites associated. Although different proprietary and standardized efforts have been made to make CoMP techniques (specially Coordinated Scheduling) available for non-ideal backhaul scenarios, those have not been massively implemented.

Other legacy techniques in the LTE domain to reduce interference are Inter-Cell Interference Coordination (ICIC), eICIC, and further enhanced ICIC (FeICIC). The latter two are typically used for environments with small cells. These techniques offer a performance far below the improvements related to Coordinated Scheduling, but typically are much easier to implement.

In the 90's GSM was the predominant mobile technology, based on a much simpler TDMA (Time Division Multiple Access) mechanism to access the medium. In GSM, frequency planning became the foundation for a proper interference mitigation. As the mobile subscribers grew, leveraged techniques were required to manage interference and overcome coverage issues. Possibly the most successful within those techniques was the frequency hopping, where the GSM TRX's (except the TRX dedicated to the Broadcast channel BCCH) “hopped” across a set of different available frequency points (the Mobile Allocation list), following some specific sequences (defined by the Hopping Sequence Number) with a starting point in the sequence determined by the MAIO parameter (Mobile Allocation Index Offset).

FIG. 2 depicts an example of the hopping pattern used in GSM. Two TRXs, each including eight time slots are show. TRX-1, the first TRX has a timeslot for BCCH transition, and therefore is not included in hopping. As reflected by a list of frequencies cycled for the other slots, the non-BCCH slots are hopped over the MA-list (f1, f2, . . . fn) that is attached to each cell. This Frequency Hopping largely improved the performance of GSM Networks in two ways:

[1] Persistent interference between specific cells, especially cochannel interference, was drastically smoothed and transformed into a much softer, bursty and sporadic interference, more widespread across multiple cells and much easier to manage by the error correction techniques. The overall result was a leveraged capacity/quality of the GSM Networks.

[2] Rayleigh fading or selective fading, originally affecting persistently to the set of UE's using some specific(s) frequency point(s) was also spread around many users and cells, making again the overall performance better as poor signal to noise ratio within a specific conversation only affected in a bursty way to a minimized number of Time Slots. Although the number of calls affected by fading was higher, the effect on each of them was much lower.

Frequency hopping in GSM had two flavors: (1) Cyclic frequency hopping: In cyclic frequency hopping, the number of available frequencies to hop around was limited by the number of existing TRX's within the cell. (2) synthetized frequency hopping, where the amount of frequencies was not restricted by the installed hardware, and finally prevailed. Frequency Hopping is still a widespread mechanism implemented in practically all GSM remaining networks worldwide.

LTE (and 5G in the future) are technologies that are orders of magnitude more sophisticated than GSM, but still some similarities can be found out. The GSM uses Time Slot (minimum and for a long time maximum radio resource allocated into a single customer while LTE uses the Physical Resource Block (PRB) as a unit of transmission resources. Until the emergence of NB-IoT, one PRB was the minimum radio resource that could be allocated to single UE. In other words, it represented the minimum granularity of the LTE carrier.

Similar to the GSM cochannel interference, where multiple simultaneous Time Slots from different cells using the same frequency point could collide, in LTE transmissions in two identical PRB's from different cells can collide unless the cells are strictly coordinated. This effect can be particularly critical in the border between the cells. Although Power Control and ICIC techniques can reduce these events, it is at the cost of limiting the amount of accessible radio resources across the geography of the cells.

The techniques described in the present document may be used in embodiments that provide a simple and backwards compatible interference and fading mitigation method in OFDM systems. Embodiments of the presently disclosed technology may extend the hopping mechanism of GSM and other TDMA systems, extending benefits to 4G, 4G Advanced, 4G Advanced Pro and 5G technologies.

### BRIEF INTRODUCTION

In some embodiments, a possible persistent interference between identical PRB's of different cells (or persistent Rayleigh fading on some specific PRB's) is transferred into a much smoother, distributed, discontinuous and bursty interference across cells and users. One benefit in such embodiments is that this will make the tasks of the error correction mechanisms much easier, resulting into an improved overall performance and capacity.

In some embodiments, the disclosed interference avoidance technique may become an intermediate practical step between the current predominant ICIC (with poor performance but easy implementation) and Coordination Scheduling (better performance but stringent backhauling and synchronization requirements).

The expansion of hopping techniques from 2G to LTE/5G presents several challenges:

The hopping sequences that in 2G were unidimensional (a simple list of accessible frequencies, in an order defined by the hopping sequence number (HSN) and starting point defined by mobile allocation index offset (MAIO) are or can be now bi-dimensional, as a specific packet data (carried within a PRB) can be associated to different subcarrier/subframe pairs in the frequency/time framework of the LTE frame. Additionally, the potential hopping values within a sequence in GSM was limited to 64 available frequency points, were in the case of LTE, the potential hopping patterns within a subframe (assuming a 20 MHz+20 MHz FDD carrier, conventional configuration) is 1021!, which is a much higher number. In embodiments that use a bi-dimensional approach (frequency+time hopping), the number of potential patterns can be as high as 8168!, what suggests that some kind of pattern simplification is useful in order to make the options manageable.

In the case of GSM, a call was using always a specific transceiver (TRX), so the pseudorandom frequency sequences were fixed in terms of number of allowed variables (the MA list) and length. In the case of LTE (and in the future 5G), a specific call can employ a variable and dynamic amount of PRB's, depending on the specific traffic and radio demands. The LTE scheduler may allocate data packets, selecting the PRB map for the overall LTE frame, on a transmit time interval (TTI) by TTI basis, and informing all UE's about the specific resources they have to access. However, in the case of LTE, a specific call may easily require a variable number of PRB's as it proceeds, hence the overall hopping sequence concept may translate into a hopping pattern to optimize the performance and processing in non-fully loaded LTE frames.

The constraints of GSM regarding TRX in hopping state was a very simple one: all TRX will hop except the Broadband Control Channel (BCCH) one. In the case of LTE, it is expected that subframes 0 (carrying broadcast and synchronization channels) and 5 (carrying synchronization channels) may not be able to be included in the hopping patterns. This may reduce the amount PRB's eligible for hopping in a 20% factor.

Hence, the initial fixed and static hopping sequences of GSM translate into constrained and dynamic hopping patterns.

In some embodiments, 2 types of hopping patterns may be used:

Unidimensional Hopping.

Hopping takes place only in frequency (subcarrier hopping) or in time (subframe hopping). In some implementations, subcarrier hopping be preferred because it may reduce not only interference but also Rayleigh fading.

Two possible implementation mechanisms are described below:

Non Load Sensitive Algorithms.

In this mode, initially the LTE scheduler works as normal, assigning data packets to PRB's. These PRBs may be called input PRB's (iPRB's), which may adopt a value from 0 to 1020 in the case of a 20+20 MHz FDD carrier. The first iPRB (iPRB 0) then is assigned an output PRB (oPRB), that will be the final physical allocation for that packet data. The iPRB 0 may adopt whatever value from 0 to 1020, while the next iPRB (iPRB 1) has one less possible value, and so on until the last iPRB of the subframe, that would be forced to occupy the only oPRB left. Conventional pseudo-random sequences where variables cannot be repeated may also be used to implement the iPRB-oPRB assignments.

Load Sensitive Algorithms.

The number of possible patterns in a single subframe for the non-load sensitive algorithm could be as high as 1021!, as the iPRB-oPRB assignment is performed for all PRB's, regardless is they carry any user data or not. A potential simplification can be achieved by executing the iPRB-oPRB impairment process only for those iPRB's that are effectively loaded, what reduces the amount of possible patterns to be managed to Πᵢ₌₁^{M}(N−i+1), wherein N is the number of PRB's within the subframe (1021 in the case of FDD 20 MHz carrier), and M is the total amount of PRB's that effectively need to carry user data. In this case, the iPRB-oPRB mapping may start as in the initial case, but will just be used based on load.

This mechanism could significantly reduce the amount of hopping patterns to be managed, especially when the system is not heavily loaded, because the length of the pseudo-random sequences to be used can be much shorter. The pseudo-random sequences used for iPRB-oPRB may be modified dynamically each time the number of user data loaded PRB's is modified.

Multidimensional Hopping or Frame Hopping.

When using this mode, the hopping may take place simultaneously in the frequency and the time domains. Although this may seem a much more complicated mechanism, actually it could be implemented as an expansion of the unidimensional case, where the potential values that a PRB may adopt is expanded (in the example used in this document from 1021 to 8168), as 8 eligible subframes have to be considered in an LTE frame. Also the number of PRB's carrying user data is expanded, as it refers to all requests within the LTE cell, not just the ones referred to a specific subframe.

Beyond larger numbers, the methodology described for the unidimensional case fully applies to the multidimensional case.

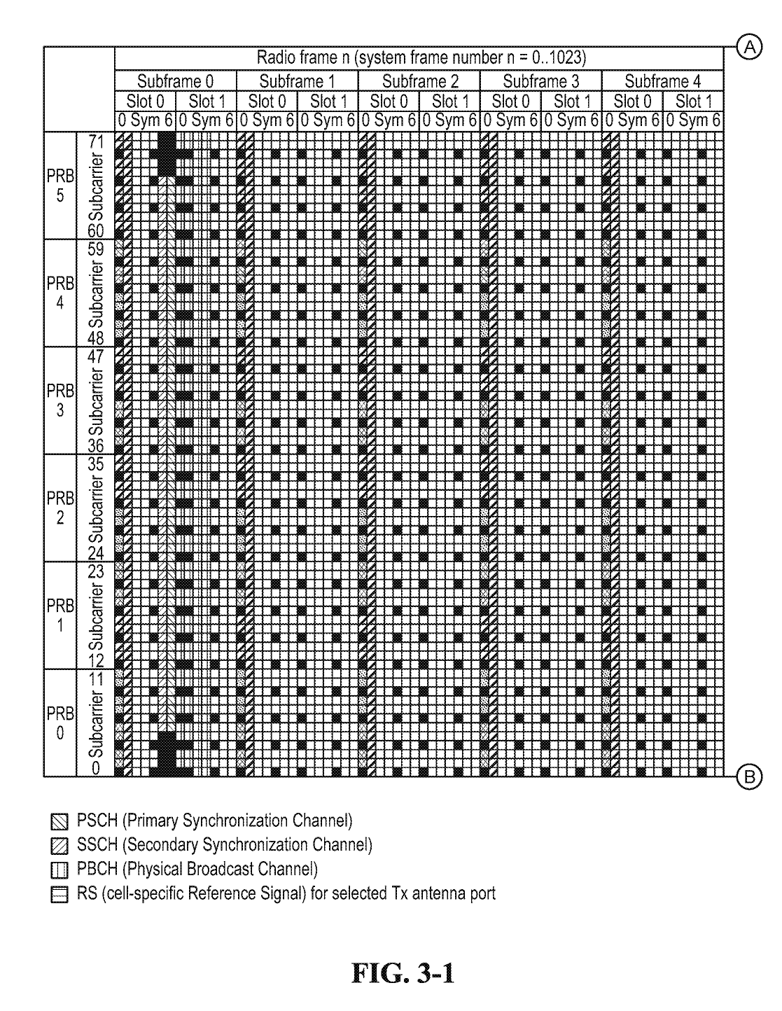

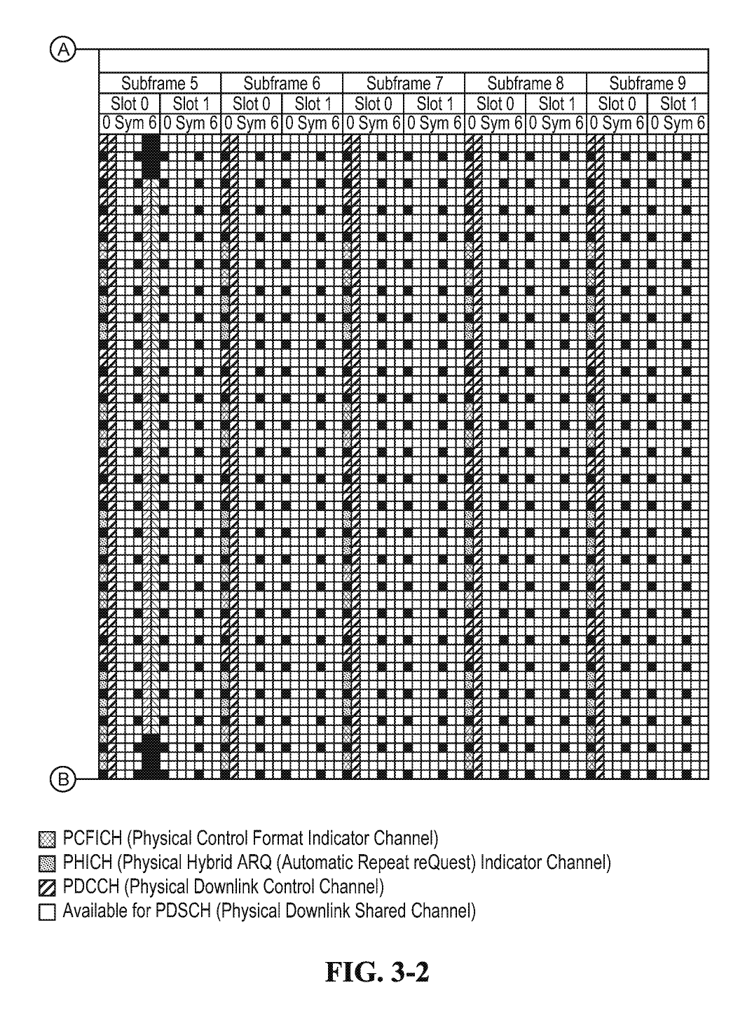

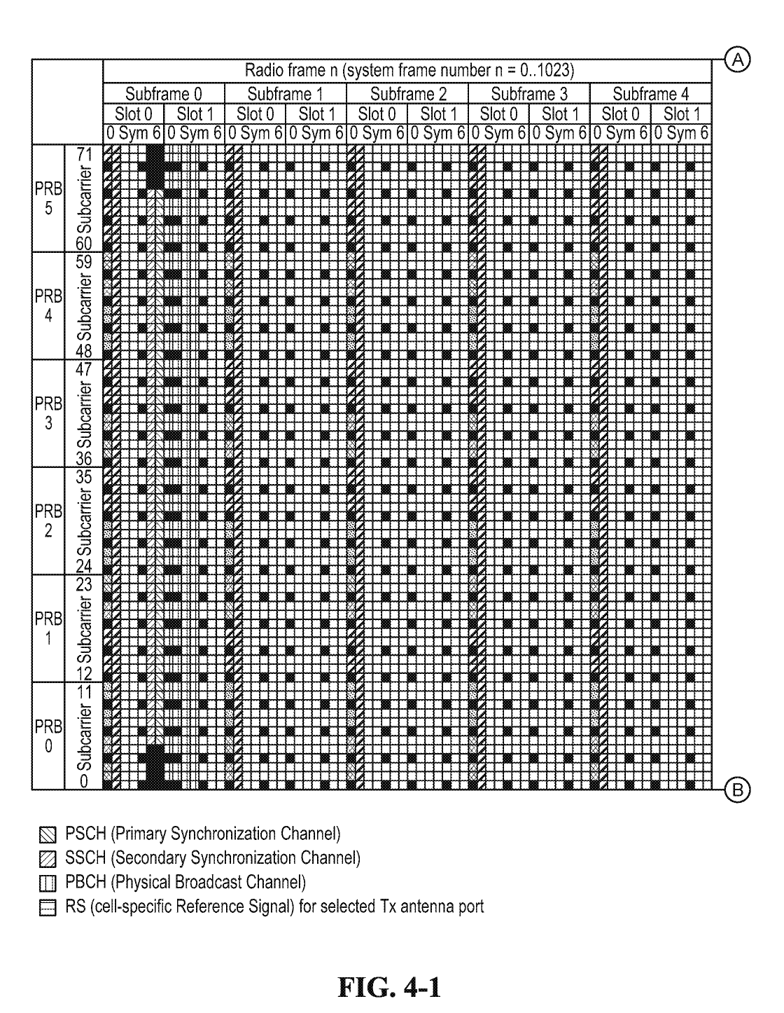

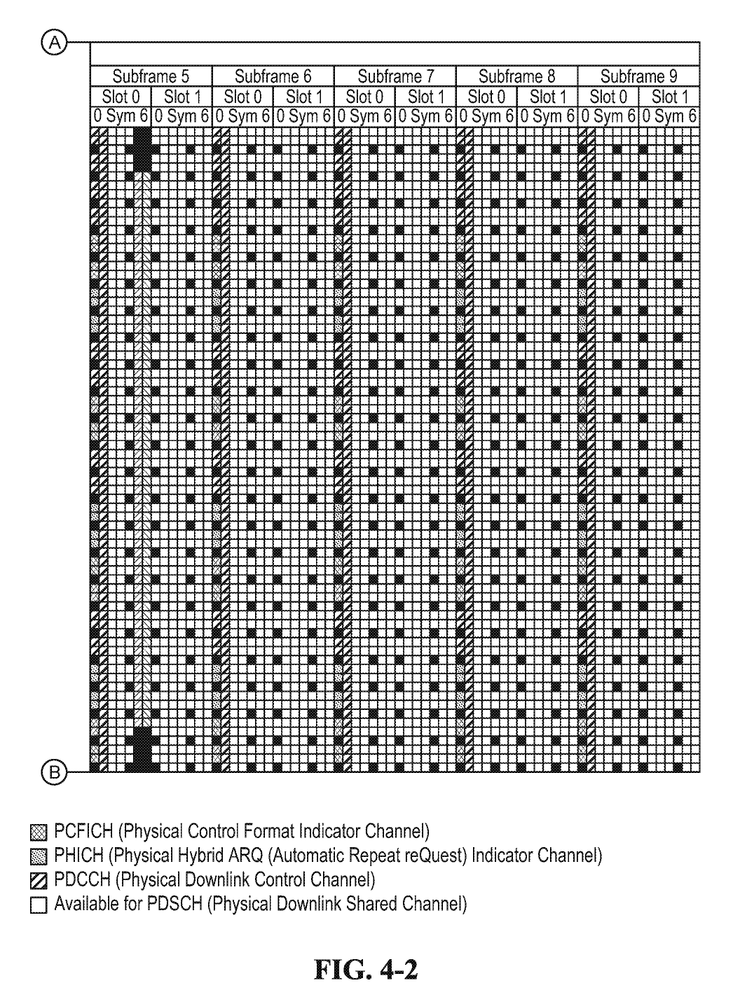

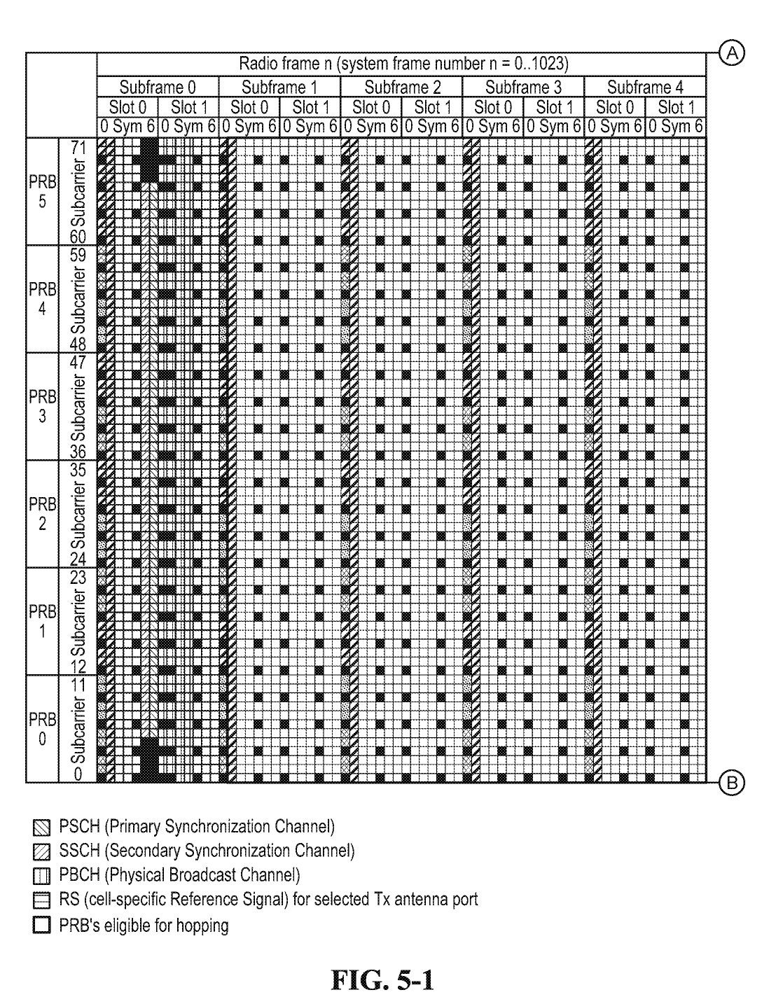

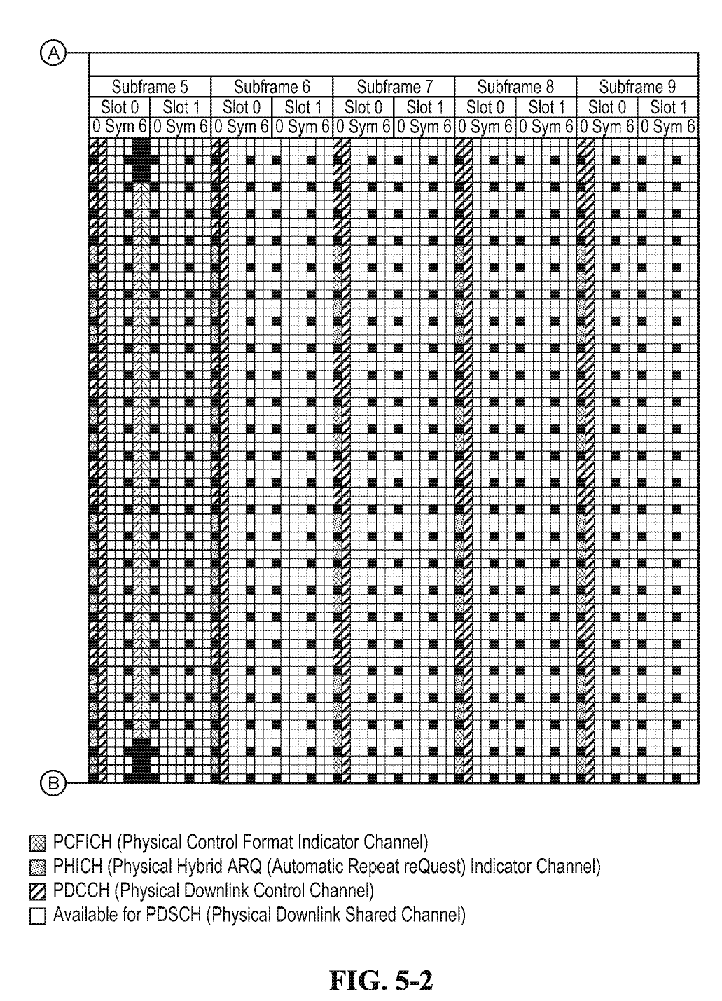

FIG. 3, FIG. 4 and FIG. 5 pictorially depict examples of resource allocation by showing resource elements (REs) in a two-dimensional graph in which the horizontal axis represents time, with the smallest grid representing a symbol transmission, and successively organized along the time axis as slots (slot 0, 1) corresponding to subframes (subframes 0 to 9) of transmission. The vertical axis represents frequency, with the smallest unit representing one subcarrier used for transmission, organized in groups of 12 subcarriers in each PRB.

In FIGS. 3-5, various REs allocated in a pre-defined manner to certain system signals, such as control messages and reference signal transmission are listed below the graphs. Some examples of such signals include primary synchronization channel (PSCH), secondary synchronization channel (SSCH), physical broadcast channel (PBCH), physical control format indicator channel (PCFICH), physical hybrid automatic repeat request indicator channel (PHICH), physical downlink control channel (PDCCH). The un-shaded REs correspond to REs available for physical downlink shared channel (PDSCH). For example, in the shaded REs, the receiving devices will expect signals of a certain kind, and therefore may not be available for re-purposing to transmission of data or signals of another type.

FIG. 3 shows an example depiction of PRBs eligible for hopping, as depicted by subframe number 1 in the case of subcarrier hopping. Along the time axis, the radio frame is divided into subframes 0 to 9, with each subframe being divided into a slot 0 and slot 1 group of resource elements, with each slot having 7 REs.

The vertical axis in FIG. 3 represents frequency in terms of subcarrier index. In the example, the vertical axis is shown to extend to six PRBs, PRB0 to PRB5, with each PRB having 12 subcarriers. As depicted in the example of subframe 1, other than the filled squares, which represent prior allocation of bandwidth to other system transmissions such as physical downlink control channel (PDCCH), Physical hybrid AEQ indicator channel (PHICH) and so on, the remaining REs of the subframe can be made available for subcarrier hopping.

FIG. 4 shows another PRB pattern illustrating an example of subframe hopping. In particular, as shown with respect to PRB0, except for subframe 0, which includes first 4 symbols in slot 1 allocated to the PBCH, the PRBs in the remaining subframes may be made available for hopping. A similar pattern will be repeated in the other PRBs also (not shown in FIG. 4 for clarity).

FIG. 5 shows an example of PRBs available for hopping in a frame hopping scheme. As depicted, all PRBs are available in all subframes, except ones that include control channels such as the PBCH and the primary and secondary synchronization channels.

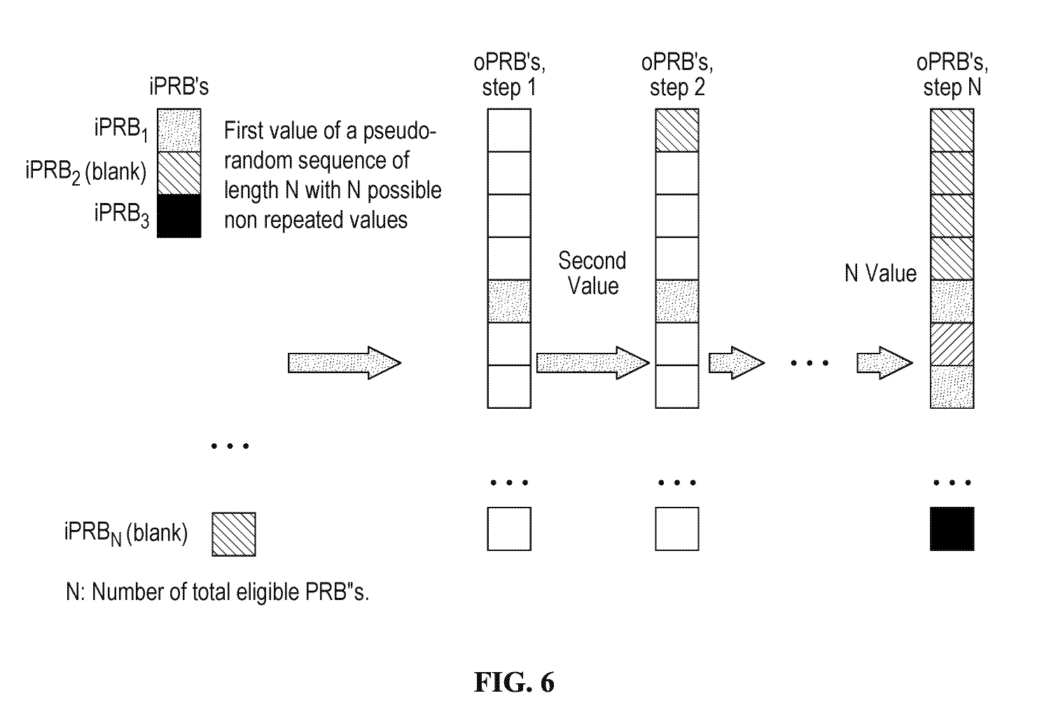

FIG. 6 shows an example of the above-described non-load sensitive iPRB-oPRB mapping example. From the iPRBs iPRB1, iPRB2, . . . iPRBN, as depicted in the left-most column, the first value of a pseudorandom sequence with N non-repeated values is used for mapping to oPRB in step 1. In the next step, the second value of the pseudorandom sequence is used for mapping to a second oPRB, as depicted in the column oPRBs step 2. This way, all values are assigned to oPRB until oPRB assignment in step N of the last iPRBn transmission resource. Alternatively or additionally, the oPRB assignments may be generated using a pseudorandom sequence that has unique entries that do not repeat for at least the maximum number of PRBs being assigned.

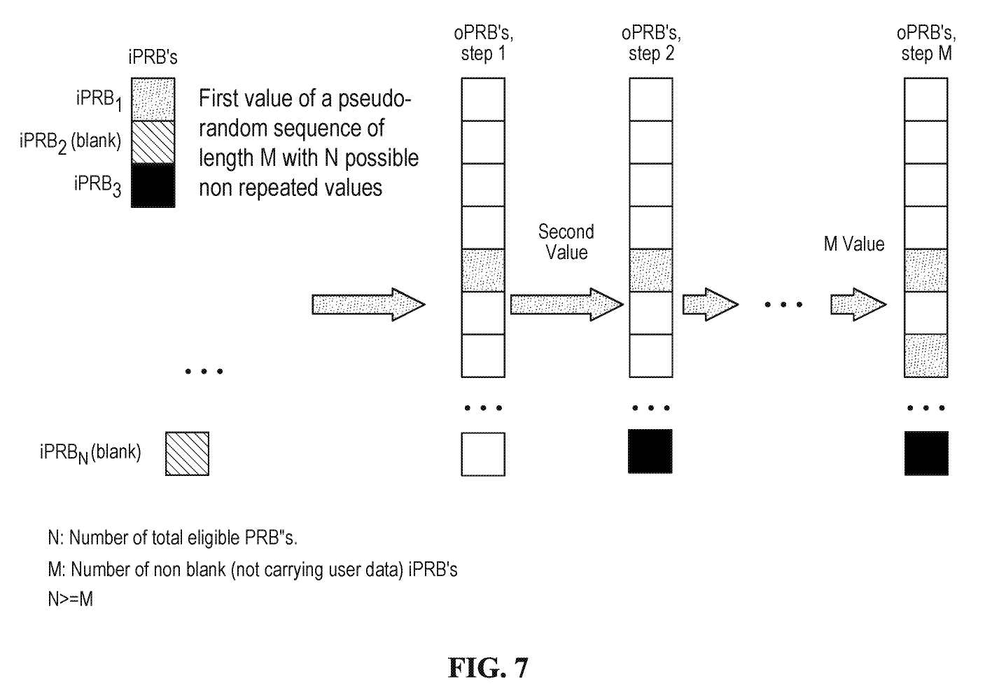

In the case of a load-sensitive mapping, as depicted in FIG. 7, N PRBs from the input may have M PRBs that are not carrying user data, where N and M are integers and N>=M. In this case, a pseudorandom sequence of length M may be used with N non-repeating values to perform the step-wise assignment of resources, as depicted by the columns titles step 1, step 2, up to step M. The gray shaded blank PRBs in the iPRB column are not mapped to any oPRB because these PRBs do not carry any data.

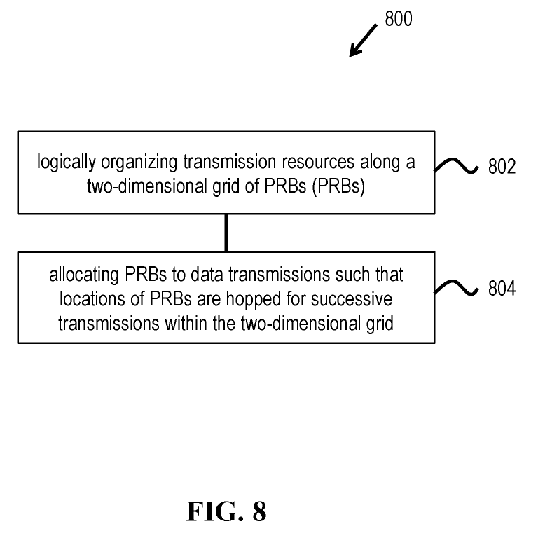

FIG. 8 is a flowchart depiction of an example method 800 of wireless communication. The method 800 may be implemented by a scheduler in a wireless network. For example, the scheduler may also be the base station of the wireless network. Alternatively, in some embodiments, the scheduler may be implemented by a hardware/software platform coupled to the base station.

The method includes, at 802, logically organizing transmission resources along a two-dimensional grid of physical resource blocks (PRBs), where each PRB is made up of a first equal number of time slots along a time dimension and a second equal number of subcarriers along a frequency dimension.

The method 800 includes, at 804, allocating PRBs to data transmissions such that locations of PRBs are hopped for successive transmissions within the two-dimensional grid.

As described in the present document, the hopping of locations of PRBs may be performed using one dimensional hopping (e.g., only in time or frequency domain) or bi-dimensional hopping (both in time and in frequency domains). In some embodiments, hopping may also be performed in the code domain (third dimension). For example, transmissions within an RE may be multiplexed using code domain orthogonality.

In some embodiments, certain transmission resources may be pre-defined to possibly carry data transmissions. Such eligible transmission resources may be organized as a set indexed by an index number. The index may extend from 1 to MAX (or 0 to MAX−1). For example, in 3GPP wireless networks, these resources may represent PRBs eligible for data transmissions. For example, in some embodiments, there may be 1020 PRBs may be available for transmission in the downlink direction. The allocation of PRBs may be performed by starting from all currently available PRBs (e.g., 1020 at the start of the process, following the conventional example used in this document). One PRB from the eligible PRB may be allocated for data transmission. Upon the allocation, the index list of currently available PRBs may be updated by removing the index entry of the PRB that got allocated. The same processor of allocation may be continued (allocating a PRB and removing the index of the allocated PRB from the list of available PRBs) until the last PRB is allocated to data transmission.

In some embodiments, a pseudorandom sequence may be used to achieve the above-described PRB allocation. For example, the pseudorandom sequence may be MAX long, and each entry of the sequence may be unique (non-repeating) entry. By using the pseudorandom sequence with unique entries for allocation, the removal of allocated PRB from the list of available PRBs is automatically achieved due to uniqueness of entries in the pseudorandom sequence.

In various embodiments, the method 800 may be implemented for data allocations in downlink direction (e.g., from a transmitter user device to a receiver user device or from base station to user terminals) or uplink direction (e.g., from user terminals to the base station or from a receiver user device to a transmitter user device).

In some embodiments, the resource allocation performed during the method 800 may use a load-sensitive algorithm in which the PRB allocation may be performed over only PRBs that are known to be loaded, or carrying data transmissions. To achieve this, some embodiments may start PRB allocation by selecting a first PRB from currently available PRBs corresponding to all MAX number of PRBs, updating the currently available PRBs by removing (a) first allocated PRB from the currently available PRBs, and (b) unused PRBs that are not carrying user data, and successively allocating every next PRB to data transmission from the currently available PRBs and reducing a number of currently available PRBs for data transmission by excluding every next allocated PRBs and unused PRBs until no PRBs are left for allocation. In some embodiments, the allocation may be achieved by using a pseudorandom sequence that has unique entries over L number of entries, where L is less than MAX (all eligible PRBs).

In Long Term Evolution (LTE) wireless networks, the above-described techniques may be implemented by modifying legacy PRB assignment algorithm used by the scheduler by performing a mapping from the legacy PRB assignments to the hopped transmission resource assignments as described herein. These assignments may be repeated with the Transmission Time Interval (TTI) as the basic unit of repetition.

In some embodiments, neighboring cells may reduce possibility of interference with each other by simply having the respective schedulers start with an initial index of the pseudorandom sequence to be different, based on sharing this information with each other. In some embodiments, a wireless network may include relay nodes that relay traffic between user terminals and a base station.

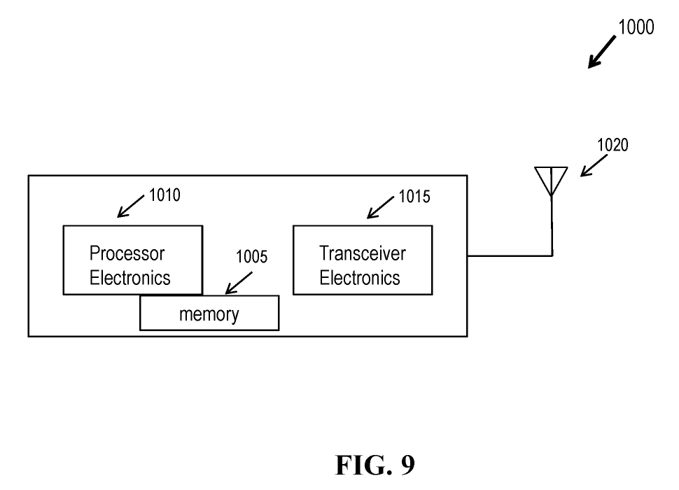

FIG. 9 is a block diagram of an example implementation of a wireless communication apparatus 1200. The method 800 may be implemented by the apparatus 1200. In some embodiments, the apparatus 1200 may be a base station of a wireless network. The apparatus 1200 includes one or more processors, e.g., processor electronics 1210, transceiver circuitry 1215 and one or more antenna 1220 for transmission and reception of wireless signals. The apparatus 1200 may include memory 1205 that may be used to store data and instructions used by the processor electronics 1210. The apparatus 1200 may also include an additional network interface to a core network or a network operator's additional equipment. This additional network interface, not explicitly shown in FIG. 9, may be wired (e.g., fiber or Ethernet) or wireless.

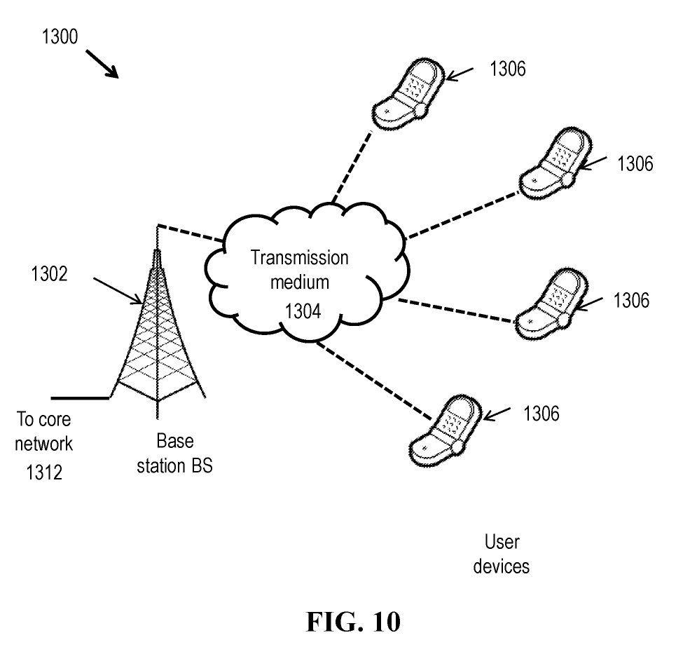

FIG. 10 depicts an example of a wireless communication system 1300 in which the various techniques described herein can be implemented. The system 1300 includes a base station 1302 that may have a communication connection with core network (1312) and to a wireless communication medium 1304 to communicate with one or more user devices 1306. The user devices 1306 could be smartphones, tablets, machine to machine communication devices, Internet of Things (IoT) devices, and so on.

It will be appreciated that techniques for randomizing transmission resources for data transmissions are disclosed. The randomization may be used in some embodiments to avoid inter-cell interferences. The randomization may also be used to avoid impairments due to interference and fading for transmissions within a given cell. It will further be appreciated that the currently used transmission resource assignment techniques in wireless networks can be easily modified using an input to output PRB mapping technique as described herein.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method implemented by a scheduler in a wireless network, comprising:
logically organizing transmission resources along a two-dimensional grid of physical resource blocks (PRBs), where each PRB is made up of a first equal number of time slots along a time dimension and a second equal number of subcarriers along a frequency dimension; and
allocating PRBs to data transmissions such that locations of PRBs are hopped for successive transmissions within the two-dimensional grid.

2. The method of claim 1, wherein the locations of PRBs are hopped along a single dimension of the two-dimensional grid.

3. The method of claim 2, wherein the single dimension is the time dimension.

4. The method of claim 2, wherein the single dimension is the frequency dimension.

5. The method of claim 1, wherein the locations of PRBs are hopped along both time and frequency dimensions.

6. The method of claim 5, wherein the PRBs eligible for data transmission are indexed from zero to MAX−1, where MAX represents total number of PRBs available for data transmission and wherein the allocating includes:
starting PRB allocation by selecting a first PRB from currently available PRBs corresponding to a MAX number of PRBs;
updating the currently available PRBs by removing first allocated PRB from the currently available PRBs; and
successively allocating every next PRB to data transmission from the currently available PRBs and reducing a number of currently available PRBs for data transmission by excluding every next allocated PRBs until all PRBs are used for allocation.

7. The method of claim 6, wherein the indexes of allocated PRBs correspond to a pseudorandom number pattern that does not repeat over at least MAX number of entries.

8. The method of claim 5, wherein all the PRBs eligible for data transmission are indexed from zero to MAX−1, where MAX represents total number of PRBs available for data transmission and wherein the allocating includes:
starting PRB allocation by selecting a first PRB from currently available PRBs corresponding to all MAX number of PRBs;
updating the currently available PRBs by removing (a) first allocated PRB from the currently available PRBs, and (b) unused PRBs that are not carrying user data; and
successively allocating every next PRB to data transmission from the currently available PRBs and reducing a number of currently available PRBs for data transmission by excluding every next allocated PRBs and unused PRBs until no PRBs are left for allocation.

9. The method of claim 1, wherein the wireless network comprises a frequency domain duplexed network.

10. The method of claim 9, wherein the data transmissions are in an uplink direction.

11. The method of claim 9, wherein the data transmissions are in a downlink direction.

12. A computer program product comprising a computer readable memory having code stored thereupon, the code, when executed, causing a processor to implement a wireless communication method, code including:
instructions for logically organizing transmission resources along a two-dimensional grid of physical resource blocks (PRBs), where each PRB is made up of a first equal number of time slots along a time dimension and a second equal number of subcarriers along a frequency dimension; and
instructions for allocating PRBs to data transmissions such that locations of PRBs are hopped for successive transmissions within the two-dimensional grid.

13. The computer program product of claim 12, wherein the locations of PRBs are hopped along both time and frequency dimensions.

14. The computer program product of claim 13, wherein the PRBs eligible for data transmission are indexed from zero to MAX−1, where MAX represents total number of PRBs available for data transmission and wherein the instructions for allocating include:
instructions for starting PRB allocation by selecting a first PRB from currently available PRBs corresponding to a MAX number of PRBs;
instructions for updating the currently available PRBs by removing first allocated PRB from the currently available PRBs; and
instructions for successively allocating every next PRB to data transmission from the currently available PRBs and reducing a number of currently available PRBs for data transmission by excluding every next allocated PRBs until all PRBs are used for allocation.

15. The computer program product of claim 14, wherein the indexes of allocated PRBs correspond to a pseudorandom number pattern that does not repeat over at least MAX number of entries.

16. The computer program product of claim 15, wherein all the PRBs eligible for data transmission are indexed from zero to MAX−1, where MAX represents total number of PRBs available for data transmission and wherein the allocating includes:
instructions for starting PRB allocation by selecting a first PRB from currently available PRBs corresponding to all MAX number of PRBs;
instructions for updating the currently available PRBs by removing (a) first allocated PRB from the currently available PRBs, and (b) unused PRBs that are not carrying user data; and
instructions for successively allocating every next PRB to data transmission from the currently available PRBs and reducing a number of currently available PRBs for data transmission by excluding every next allocated PRBs and unused PRBs until no PRBs are left for allocation.

17. A device for wireless communication, comprising a processor configured to implement a method comprising:
logically organizing transmission resources along a two-dimensional grid of physical resource blocks (PRBs), where each PRB is made up of a first equal number of time slots along a time dimension and a second equal number of subcarriers along a frequency dimension; and
allocating PRBs to data transmissions such that locations of PRBs are hopped for successive transmissions within the two-dimensional grid.

18. The device of claim 17, wherein the locations of PRBs are hopped along a single dimension of the two-dimensional grid.

19. The device of claim 18, wherein the single dimension is the time dimension.

20. The device of claim 18, wherein the single dimension is the frequency dimension.

21. The device of claim 17, wherein the locations of PRBs are hopped along both time and frequency dimensions.
